(19) United States
(12) Patent Application Publication
(10) Pub. No.: US 2009/0226713 A1
(43) Pub. Date: Sep. 10, 2009

(54) Siding Panel Formed of Polymer and Wood Flour

(76) Inventors: Daniel E. Festa, Strongsville, OH (US); Ko Das, Copley, OH (US)

Correspondence Address: BANNER & WITCOFF, LTD., 28 STATE STREET, 28th FLOOR, BOSTON, MA, 02109-9601, US

(21) Appl. No.: 12/414,746

(22) Filed: Mar. 31, 2009

Related U.S. Application Data
(63) Continuation-in-part of application No. 11/380,243, filed on Apr. 26, 2006.

(51) Int. Cl. B32B 23/08

(52) U.S. Cl. 428/332; 428/512

(57) ABSTRACT

A composite siding panel has a core including PVC resin, wood flour in an amount of about 75 to about 300 parts per hundred parts of PVC resin, a thermal stabilizer in an amount of about 1.2 parts per hundred parts of PVC resin, and a wood stabilizer in an amount of about 0.5 to about 3 parts per hundred parts of PVC resin; and a cap covering a front, a back, a bottom, and a top of the core.

This application is a continuation-in-part application of U.S. application Ser. No. 11/380,243, filed Apr. 26, 2006.

### FIELD

This invention relates generally to a composite siding panel and, in particular, to a composite siding panel formed of a polymer and wood flour.

### BACKGROUND

Siding products for building structures can be formed of many materials, including wood, polymer or vinyl materials such as polyvinyl chloride (PVC), and fiber cement. It is desirable to produce a siding product that provides weatherability, durability, low maintenance, and adaptability to various architectures. Vinyl siding is very flexible, which means that it will follow a wall very closely. Wood and fiber cement products, on the other hand, are more rigid, allowing the siding to help true a wall that is uneven.

It is an object of the present invention to provide a siding panel that reduces or overcomes some or all of the difficulties inherent in prior known devices. Particular objects and advantages will be apparent to those skilled in the art, that is, those who are knowledgeable or experienced in this field of technology, in view of the following disclosure of the invention and detailed description of certain embodiments.

### SUMMARY

The principles of the invention may be used to advantage to provide a composite panel formed of a polymer and wood flour. In accordance with a first aspect, a composite siding panel has a core including PVC resin, wood flour in an amount of about 75 to about 300 parts per hundred parts of PVC resin, a thermal stabilizer in an amount of about 1.2 parts per hundred parts of PVC resin, and a wood stabilizer in an amount of about 0.5 to about 3 parts per hundred parts of PVC resin; and a cap covering a front, a back, a bottom, and a top of the core.

In accordance with another aspect, a composite siding panel has a core including PVC resin, wood flour in an amount of about 75 to about 300 parts per hundred parts of PVC resin, a thermal stabilizer in an amount of about 1.2 parts per hundred parts of PVC resin, a wood stabilizer in an amount of about 0.5 to about 3 parts per hundred parts of PVC resin, a high molecular weight process aid in an amount of about 4 to about 14 parts per hundred parts of PVC resin, an impact modifier in an amount of about 1 to about 5 parts per hundred parts of PVC resin, a low molecular weight process aid in an amount of about 1 to about 3 parts per hundred parts of PVC resin, calcium carbonate in an amount of about 25 to about 125 parts per hundred parts of PVC resin, calcium stearate in an amount of about 1 to about 2 parts per hundred parts of PVC resin, and a lubricant in an amount of about 10 to about 20 parts per hundred parts of PVC resin, and a cap covering a front, a back, a bottom, and a top of the core.

In accordance with a further aspect, a composite siding panel has a core including PVC resin, wood flour in an amount of about 166 parts per hundred parts of PVC resin, a thermal stabilizer in an amount of about 1.2 parts per hundred parts of PVC resin, a wood stabilizer in an amount of about 1 part per hundred parts of PVC resin, a high molecular weight process aid in an amount of about 6 parts per hundred parts of PVC resin, an impact modifier in an amount of about 2 parts per hundred parts of PVC resin, a low molecular weight process aid in an amount of about 2 parts per hundred parts of PVC resin, calcium carbonate in an amount of about 75 parts per hundred parts of PVC resin, calcium stearate in an amount of about 1.5 parts per hundred parts of PVC resin, and a lubricant in an amount of about 14 parts per hundred parts of PVC resin; and a cap covering a front, a back, a bottom, and a top of the core.

Substantial advantage is achieved by providing a composite panel formed of a polymer and wood flour. In particular, certain embodiments of a polymer and wood flour composite siding panel exhibit the best attributes of existing exterior cladding materials, e.g., appearance, durability, maintenance and cost. Such composite panels have low maintenance, excellent weatherability and durability, and can easily be adapted to various architectures. Such composite panels also are somewhat flexible, resulting in less breakage at job sites, while at the same time being rigid enough to help true an uneven wall.

These and additional features and advantages disclosed here will be further understood from the following detailed disclosure of certain embodiments.

### BRIEF DESCRIPTION OF THE DRAWINGS

FIG. 1 is a perspective view of a composite siding panel.

The FIGURE referred to above is not drawn necessarily to scale and should be understood to provide a representation of the invention, illustrative of the principles involved. Some features of the composite panel of a polymer and wood flour depicted in the drawing have been enlarged or distorted relative to others to facilitate explanation and understanding. Composite panels of a polymer and wood flour as disclosed herein would have configurations and components determined, in part, by the intended application and environment in which they are used.

### DETAILED DESCRIPTION OF CERTAIN PREFERRED EMBODIMENTS

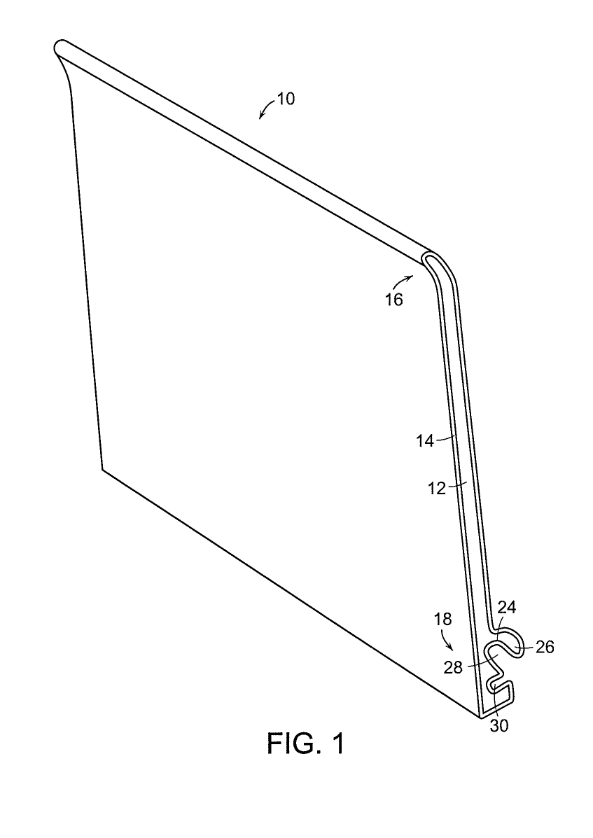

An illustrative embodiment of a composite panel 10 is shown in FIG. 1. Composite panel 10 may be used, for example, as a siding material for a building. In the illustrated embodiment panel 10 has a core 12 encased within a cap 14. Cap 14 surrounds the full, or complete, perimeter of the profile of core 12, that is, cap 14 covers a front, back, top and bottom of core 12. Cap 14 provides a moisture barrier about the perimeter of the profile of core 12. In certain embodiments, a thickness of cap 14 is between approximately 10 mils and approximately 15 mils. It is to be appreciated that in certain embodiments, panel 10 may not include cap 14.

Panel 10 includes a top lock 16 proximate a top edge of panel 10, and a bottom lock 18 proximate a bottom edge of the panel. Top and bottom locks 16, 18 can have a wide range of shapes, and are configured to have complimentary shapes so that vertically adjacent siding panels can be interlocked together.

In certain embodiments, top lock 16 is angled slightly outwardly from a front surface of panel 10. Bottom lock 18 includes a flange 24 extending rearwardly from panel 10 proximate its bottom edge, and terminates in a lip 26 extending downwardly from a rear edge of flange 24. A first recess 28 is formed in a rear surface panel 10 beneath flange 24. A second recess 30 is formed in the rear surface of panel 10 below first recess 28. First recess 28 is configured to mate with and receive top lock 16 of a vertically adjacent panel 10. Panel 10 may be secured to a horizontally adjacent panel via a splicer. An exemplary splicer and installation of panel 10 on a building structure are described in greater detail in U.S. application Ser. No. 10/911,932, the entire disclosure of which is incorporated herein by reference for all purposes.

Core 12 of panel 10 is formed of a composite of a thermoplastic polymer, wood flour and additional materials. In certain embodiments, panel 10 is formed primarily of polyvinyl chloride (PVC) resin and wood flour. The PVC resin serves as the body or primary structure of panel 10. The PVC resin may be a low molecular weight, vinyl suspension resin. In certain embodiments, comprises between about 17.37% and about 45.52% total weight of panel 10. In yet other embodiments, the PVC resin comprises about 27.01% total weight of panel 10.

Wood flour, which is formed of small wood particles, acts as a cellulose filler and, therefore, significantly reduces the cost of a polymer siding panel. In certain embodiments, 40 mesh wood flour is used, with the particles having a maximum dimension of approximately 425 microns, or 0.425 mm.

The wood flour helps produce a stiffer, more stable product. Further, the wood flour serves to reduce the thermal expansion of the siding panel, resulting in a significant reduction in movement of the siding panel along the wall or other structure upon which it is installed. By reducing the movement of the panels, butt seams rather than overlapping seams can be used, improving the appearance of the siding.

In certain embodiments, between about 75 parts per hundred resin (pphr) and about 300 pphr of wood flour is combined with the polymer, or between about 21.39% and about 67.46% total weight. In yet other embodiments, about 166 pphr of wood flour is used, or about 44.84% total weight of the composite panel.

A thermal stabilizer, or resin stabilizer, acts to stabilize and allow for the processing of the PVC resin, thereby helping reduce the chances of burning or degrading of the PVC resin during processing. A thermal stabilizer also helps to promote the retention of physical properties required by outdoor weatherable building products. Suitable thermal stabilizers for the composition include all of the generally known thermal stabilizers in the PVC art, including metal soaps, epoxidized oils, alkyl and aryl phosphites, hindered phenols (with metal soaps), organotin mercaptides and organotin mercaptoesters, polyhydric alcohols, mixed-metal stabilizers (e.g., Zn/Cd) and basic lead stabilizers. Organotin stabilizers are commercially available and include methyl tins, butyltins, octyltins, and estertins. Various organotin derivatives including sulfides, oxides, carboxylates (salts of fatty acids and maleic acid), unsubstituted mercaptides, mercaptoacid esters, mercaptoalcohol esters, and mercaptocarboxylates are suitable as well. An exemplary resin stabilizer is a liquid methyltin mercaptide, such as ADVASTAB TM-181, supplied by Rohm and Haas.

In certain embodiments, the resin stabilizer comprises between about 0.21% and about 0.55% total weight of panel 10. In certain embodiments, about 1.2 pphr, or about 0.32% total weight of resin stabilizer is used.

A wood stabilizer may be used to help stabilize the wood flour and reduce the chances of burning and degrading of the wood flour during processing. Suitable wood stabilizers include oxidized polyethylene waxes. An exemplary wood stabilizer is LLC WSTAB 100, provided by Lake County Consultants of Greenfield, Ind.

In certain embodiments, between about 0.5 pphr and about 3 pphr of wood stabilizer is used, or between about 0.09% and about 1.35% total weight. In yet other embodiments, about 1 pphr, or about 0.27% total weight wood stabilizer is used.

An impact modifier may also be added to the composite mixture in order to improve the resistance of the composite panel to impacts. Suitable impact modifiers known in the art are commercially available and include the commonly known “multistage” or “core/shell” polymer particles prepared substantially from methacrylate, butadiene, and styrene (e.g., “MBS”) resins. An exemplary MBS impact modifier is Paraloid BTA-753 ER, supplied by Rohm and Haas.

In certain embodiments, between about 1 pphr and about 5 pphr, or between about 0.17% and about 2.24% total weight impact modifier is added to the composite mixture. In yet other embodiments, about 2 pphr, or about 0.54% total weight impact modifier is added to the composite mixture.

Calcium carbonate may also be added to the composite panel mixture in certain embodiments, acting as a mineral filler with the product matrix. An exemplary calcium carbonate is OMYACAB-UFT, provided by Omya Inc. of Proctor, Vt.

In certain embodiments, between about 25 pphr and about 125 pphr, or between about 5.26% and about 39.10% total weight calcium carbonate is used. In yet other embodiments, about 75 pphr, or about 20.26% total weight calcium carbonate is added to the composite mixture.

In certain embodiments, process aids are added to the mixture. The process aids help promote fusion of the PVC resin during extrusion processing and help develop a uniform cell structure. They also help to develop substantial melt strength in a smooth-surfaced, foamed PVC extrudate at relatively low densities. Suitable process aids include acrylic polymers.

In some embodiments, both high molecular weight acrylic polymers and low molecular weight acrylic polymers may be used as process aids. A low molecular weight acrylic polymer also acts as an external lubricant to provide metal release, thereby helping prevent the PVC from adhering to the heated surfaces of the extrusion equipment.

An exemplary high molecular weight acrylic polymer is Paraloid K-400, provided by Rohm and Haas, which is formed of methyl methacrylate (MMA), butyl methacrylate (BMA), and butyl acrylate (BA), with an average molecular weight of approximately 6 million. An exemplary low molecular weight acrylic polymer is Paraloid K-175, provided by Rohm and Haas, which is formed of methyl methacrylate (MMA), butyl acrylate (BA), and styrene, with an average molecular weight of approximately 110,000.

In certain embodiments, between about 4 pphr and about 14 pphr, or between about 0.71% and about 6.09% total weight of high molecular weight process aids are added to the composite mixture. In yet other embodiments, about 6 pphr, or about 1.62% total weight of high molecular weight process aids are added to the composite mixture.

In certain embodiments, between about 1 pphr and about 3 pphr, or between about 0.17% and about 1.35% total weight low molecular weight process aids are used. In yet other embodiments, about 2 pphr, or about 0.54% total weight of low molecular weight process aids are added to the composite mixture.

A lubricant may also be used in certain embodiments during formation of the composite panel. The lubricant serves to help process the wood and resin composite, provide viscosity control, and reduce friction, thereby decreasing mixing times and energy required. Suitable lubricants include synthetic oils such as polyalpha-olefin (PAO), synthetic esters, polyalkylene glycols (PAG), phosphate esters, alkylated naphthalenes (AN), silicate esters, and ionic fluids. Exemplary lubricants also include blends of waxes, oleo chemicals and aliphatic resins, such as SA 0413, supplied by Struktol Company of America of Stow, Ohio.

In certain embodiments, lubricant in an amount between about 10 pphr and about 20 pphr, or between about 1.77% and about 8.71% total weight is added. In yet other embodiments, about 14 pphr, or about 3.78% total weight lubricant is added to the composite mixture.

A foaming agent, or blowing agent, may be used in certain embodiments to introduce air into the panel, thereby reducing its weight and improving throughput during manufacture of the panel. Suitable foaming agents include endothermic foaming agents, which are not self-reactive, and absorb heat during thermal decomposition. An exemplary foaming agent is GMA-215, provided by KibbeChem of Elkhart, Ind.

In certain embodiments, between about 1 pphr and about 2.5 pphr foaming agent is used, or between about 0.17% and about 1.13% total weight. In yet other embodiments, about 1.5 pphr, or about 0.41% total weight foaming agent is used.

Calcium stearate may be used in certain embodiments. Calcium stearate is a multi-functional process aid which serves to not only improve fusion but also aids in the flowability of the blended material. Calcium stearate is a non-toxic stabilizer and lubricant. It is an insoluble calcium salt of stearic acid. It may be provided as a 50% dispersion in water or as a spray dried powder. In certain embodiments, between about 1 pphr and about 2.0 pphr calcium stearate is used, or between about 0.17% and about 0.91% total weight. In yet other embodiments, about 1.5 pphr, or about 0.41% total weight calcium stearate is used.

One example of an embodiment of composite panel 10 is illustrated in the following table:

TABLE 1

| | Parts Per | |
|---|---|---|
| | Hundred | |
| Element | Resin (pphr) | Percentage (%) |
| PVC Resin | 100 | 27.01 |
| Wood Flour | 166 | 44.84 |
| Thermal (Resin) Stabilizer | 1.2 | 0.32 |
| Process Aid (High Molec. Wt.) | 6 | 1.62 |
| Impact Modifier | 2 | 0.54 |
| Wood Stabilizer | 1 | 0.27 |
| Lubricating Process Aid (Lo Mol Wt.) | 2 | 0.54 |
| Lubricant | 14 | 3.78 |
| Calcium Carbonate | 75 | 20.26 |
| Calcium Stearate | 1.5 | 0.41 |
| Foaming Agent | 1.5 | 0.41 |

Cap 14 may be formed of PVC, for example. Cap 14 provides a protective cover for panel 10, enhancing the weatherability of composite panel 10, and eliminating the need to paint the panel.

To form panel 10, the PVC resin, stabilizer, process aid, impact modifier, wood stabilizer, lubricating process aid, and calcium carbonate are mixed in a high intensity blender. They are then heated to a temperature greater than about 248° F., and then cooled in a cool mixer to about 120° F. The resulting powdered mixture is then bagged and taken to an extruder.

At the extruder, all components are fed into a gravimetric control system and commingled into a homogenous mixture. This ensures that a consistent material feedstock is delivered to the extruder. The material is then extruded through a high pressure die. The extruded material is then further processed with either calibration or a belt. With calibration, a calibrator is positioned close to, but not touching, the die. The calibrator cools and maintains the profile of the panel as it exits the die. With the belt, the material exits the die and is fed into a twin belt system. The extrudate fills the cavity between the belts, and the material is embossed and shaped into a substantially flat panel, including any desired lips or other features. The belt cools the panel to some extent, and a water-cooled tank is used to finish the cooling process.

The resultant panel 10 provides a siding material with excellent appearance and durability, and low maintenance and cost. The PVC component provides panel 10 with flexibility, while the added flour gives it enough rigidity to allow the panel to help true a wall that is uneven.

In light of the foregoing disclosure of the invention and description of various embodiments, those skilled in this area of technology will readily understand that various modifications and adaptations can be made without departing from the scope and spirit of the invention. All such modifications and adaptations are intended to be covered by the following claims.

What is claimed is:

1. A composite siding panel comprising, in combination:
a core comprising:
PVC resin;
wood flour in an amount of about 75 to about 300 parts per hundred parts of PVC resin;
a thermal stabilizer in an amount of about 1.2 parts per hundred parts of PVC resin; and
a wood stabilizer in an amount of about 0.5 to about 3 parts per hundred parts of PVC resin; and
a cap covering a front, a back, a bottom, and a top of the core.

2. The composite siding panel of claim 1, wherein the core further comprises a high molecular weight process aid in an amount of about 4 to about 14 parts per hundred parts of PVC resin.

3. The composite siding panel of claim 1, wherein the core further comprises an impact modifier in an amount of about 1 to about 5 parts per hundred parts of PVC resin.

4. The composite siding panel of claim 1, wherein the core further comprises a low molecular weight process aid in an amount of about 1 to about 3 parts per hundred parts of PVC resin.

5. The composite siding panel of claim 1, wherein the core further comprises calcium carbonate in an amount of about 25 to about 125 parts per hundred parts of PVC resin.

6. The composite siding panel of claim 1, wherein the core further comprises a lubricant in an amount of about 10 to about 20 parts per hundred parts of PVC resin.

7. The composite siding panel of claim 1, wherein the core further comprises calcium stearate in an amount of about 1 to about 2 parts per hundred parts of PVC resin.

8. The composite siding panel of claim 1, wherein the core further comprises a foaming agent in an amount 1 to about 2.5 parts per hundred parts of PVC resin.

9. The composite siding panel of claim 1, wherein the wood flour is present in an amount of about 166 parts per hundred parts of PVC resin.

10. The composite siding panel of claim 1, wherein the wood stabilizer is present in amount of about 1 part per hundred parts of PVC resin.

11. The composite siding panel of claim 1, wherein the core further comprises a high molecular weight process aid in an amount of about 6 parts per hundred parts of PVC resin.

12. The composite siding panel of claim 1, wherein the core further comprises an impact modifier in an amount of about 2 parts per hundred parts of PVC resin.

13. The composite siding panel of claim 1, wherein the core further comprises a low molecular weight process aid in an amount of about 2 parts per hundred parts of PVC resin.

14. The composite siding panel of claim 1, wherein the core further comprises calcium carbonate in an amount of about 75 parts per hundred parts of PVC resin.

15. The composite siding panel of claim 1, wherein the core further comprises a lubricant in an amount of about 14 parts per hundred parts of PVC resin.

16. The composite siding panel of claim 1, wherein the core further comprises calcium stearate in an amount of about 1.5 parts per hundred parts of PVC resin.

17. The composite siding panel of claim 1, wherein the core further comprises a foaming agent in an amount of about 1.5 parts per hundred parts of PVC resin.

18. The composite siding panel of claim 13, wherein the cap is formed of PVC.

19. The composite siding panel of claim 1, wherein the cap has a thickness between approximately 10 mils and approximately 15 mils.

20. A composite siding panel comprising, in combination:
a core comprising:
PVC resin;
wood flour in an amount of about 75 to about 300 parts per hundred parts of PVC resin;
a thermal stabilizer in an amount of about 1.2 parts per hundred parts of PVC resin;
a wood stabilizer in an amount of about 0.5 to about 3 parts per hundred parts of PVC resin;
a high molecular weight process aid in an amount of about 4 to about 14 parts per hundred parts of PVC resin;
an impact modifier in an amount of about 1 to about 5 parts per hundred parts of PVC resin;
a low molecular weight process aid in an amount of about 1 to about 3 parts per hundred parts of PVC resin;
calcium carbonate in an amount of about 25 to about 125 parts per hundred parts of PVC resin;
calcium stearate in an amount of about 1 to about 2 parts per hundred parts of PVC resin; and
a lubricant in an amount of about 10 to about 20 parts per hundred parts of PVC resin; and
a cap formed of PVC and covering a front, a back, a bottom, and a top of the core.

21. A composite siding panel comprising, in combination:
a core comprising:
PVC resin;
wood flour in an amount of about 166 parts per hundred parts of PVC resin;
a thermal stabilizer in an amount of about 1.2 parts per hundred parts of PVC resin;
a wood stabilizer in an amount of about 1 part per hundred parts of PVC resin;
a high molecular weight process aid in an amount of about 6 parts per hundred parts of PVC resin;
an impact modifier in an amount of about 2 parts per hundred parts of PVC resin;
a low molecular weight process aid in an amount of about 2 parts per hundred parts of PVC resin;
calcium carbonate in an amount of about 75 parts per hundred parts of PVC resin;
calcium stearate in an amount of about 1.5 parts per hundred parts of PVC resin; and
a lubricant in an amount of about 14 parts per hundred parts of PVC resin; and
a cap formed of PVC and covering a front, a back, a bottom, and a top of the core.
